(19) United States
(12) Patent Application Publication
(10) Pub. No.: US 2022/0209956 A1
(43) Pub. Date: Jun. 30, 2022

(54) METHOD FOR PERFORMING A TRANSACTION ON THE BLOCK CHAIN AND COMPUTER PROGRAM PRODUCT

(71) Applicant: BAYPAY PTE LTD., Taipei City (TW)

(72) Inventor: Chung-Yung YEH, Taipei City (TW)

(21) Appl. No.: 17/139,158

(22) Filed: Dec. 31, 2020

(51) Int. Cl. H04L 9/32; G06Q 20/38; G06Q 20/40; G06Q 20/36

(52) U.S. Cl. CPC H04L 9/3239; G06Q 20/3825; H04L 9/3247; G06Q 2220/00; G06Q 20/36; H04L 2209/38; H04L 2209/56; G06Q 20/401

(57) ABSTRACT

A computer program product includes a receiving module, a security module and a transmitting module. The receiving module is configured to receive identification data of a user ID from a mobile device at a time with a timestamp parameter t. The security module for storing activity parameter p is configured to identify the identification data. The security module generates a digital signature and a block chain ledger C corresponding to a block chain as a function C=f(ID, t, p). The transmitting module is configured to transmit the digital signature and the block chain ledger C to the mobile device. The mobile device accesses the block chain by using the digital signature and the block chain ledger C to perform a transaction on the block chain.

### BACKGROUND

### 1. Technical Field

The present disclosure relates to a method for performing a transaction on the block chain and a computer program product.

### 2. Description of the Related Art

To perform a transaction on the block chain, methods for identifying users by a third party have been developed. In real life, the government would issue an identity card (including a number) to verify the identity of the user. In the virtual internet world, a user also needs an internet authentication. In particular, the user needs to prove the identity in the block chain so that a transaction on the block chain may be performed.

### SUMMARY

In accordance with some embodiments of the present disclosure, a computer program product includes a receiving module, a security module and a transmitting module. The receiving module is configured to receive identification data of a user ID from a mobile device at a time with a timestamp parameter t. The security module for storing activity parameter p is configured to identify the identification data. The security module generates a digital signature and a block chain ledger C corresponding to a block chain as a function C=f(ID, t, p). The transmitting module is configured to transmit the digital signature and the block chain ledger C to the mobile device. The mobile device accesses the block chain by using the digital signature and the block chain ledger C to perform a transaction on the block chain.

In accordance with some embodiments of the present disclosure, a method for performing a transaction on the block chain comprises: receiving identification data of a user ID from a mobile device at a time with a timestamp parameter t; providing activity parameter p; generating a digital signature and a block chain ledger C corresponding to a block chain as a function: C=f(ID, t, p); and storing the digital signature and the block chain ledger C in the block chain.

### BRIEF DESCRIPTION OF THE DRAWINGS

Aspects of the present disclosure are best understood from the following detailed description when read with the accompanying drawings. It is noted that various features may not be drawn to scale, and the dimensions of the various features may be arbitrarily increased or reduced for clarity of discussion.

FIG. 1 illustrates a block diagram of a communication system in accordance with some embodiments of the present disclosure.

FIG. 2 illustrates a flow chart showing a method for performing a transaction on the block chain in accordance with some embodiments of the present disclosure.

FIG. 3 illustrates a block diagram of a communication system in accordance with some embodiments of the present disclosure.

Common reference numerals are used throughout the drawings and the detailed description to indicate the same or similar components. The present disclosure will be readily understood from the following detailed description taken in conjunction with the accompanying drawings.

### DETAILED DESCRIPTION

Various embodiments of the present disclosure are discussed in detail below. It should be appreciated, however, that the embodiments set forth many applicable concepts that can be embodied in a wide variety of specific contexts. It is to be understood that the following disclosure provides for many different embodiments or examples of implementing different features of various embodiments. Specific examples of components and arrangements are described below for purposes of discussion. These are, of course, merely examples and are not intended to be limiting.

Embodiments, or examples, illustrated in the drawings are disclosed below using specific language. It will nevertheless be understood that the embodiments and examples are not intended to be limiting. Any alterations and modifications of the disclosed embodiments, and any further applications of the principles disclosed in this document, as would normally occur to one of ordinary skill in the pertinent art, fall within the scope of this disclosure.

In addition, the present disclosure may repeat reference numerals and/or letters in the various examples. This repetition is for the purpose of simplicity and clarity and does not in itself dictate a relationship between the various embodiments and/or configurations discussed.

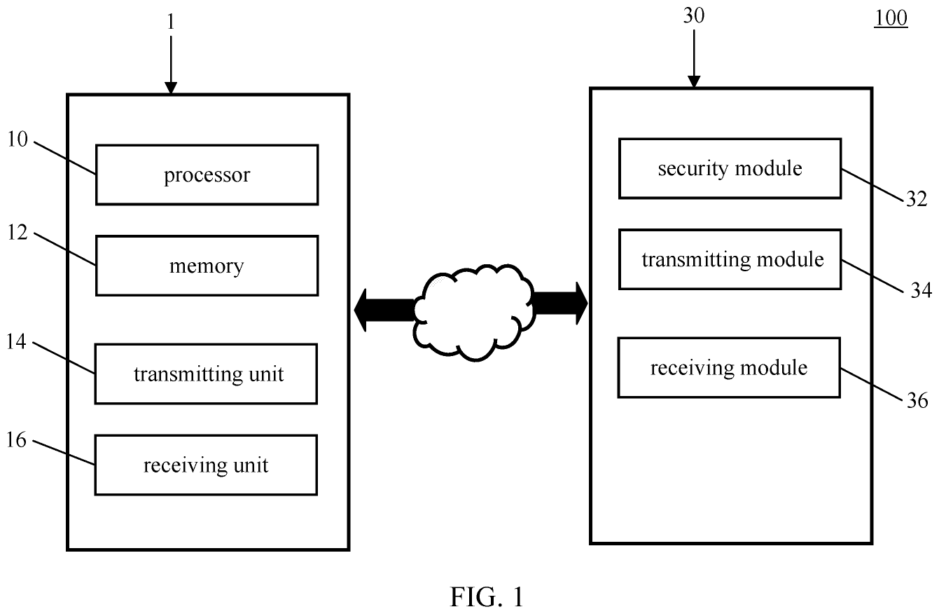

FIG. 1 illustrates a block diagram of a communication system 100 in accordance with some embodiments of the present disclosure. The communication system 100 includes a computing system. The communication system 100 may include a computer program product 30 communicating with a mobile device 1. In some embodiments, the communication system 100 may include a computer program product 30 wirelessly communicating with a mobile device 1. The computer program product 30 includes a receiving module 36, a security module 32 and a transmitting module 34. In some embodiments, the computer program product 30 is stored in cloud (such as an internet server, or etc.). The computer program product 30 may be included in one computer or one server. In some embodiments, the computer program product 30 may be distributed in multiple computers. The program product 30 may be executed by the communication system 100 in a distribution manner.

In some embodiments, the receiving module 36 is configured to receive identification data of a user ID from a mobile device 1 at a time with a timestamp parameter t. In some embodiments, the timestamp parameter t may correspond to the Year, month, day, minute and/or second. In some embodiments, the timestamp parameter t may be, for example, 10:50, Dec. 31, 2020. In some embodiments, the security module 32 for storing activity parameter p is configured to identify the identification data from the mobile device 1. In some embodiments, the mobile device 1 is a mobile phone, cell phone, smart phone or other suitable devices. The security module 32 generates a digital signature and a block chain ledger C corresponding to a block chain as a function: C=f(ID, t, p) (user ID, timestamp parameter t and activity parameter p). In some embodiments, the security module 32 includes a database for verifying the identification data.

In some comparative embodiment, the security module 32 generates a digital signature and a block chain ledger C corresponding to a block chain: C=f(ID, p). In the comparative embodiment, the security module 32 only refers to the identification data ID and activity parameter p. Since the timestamp parameter t is not considered, the block chain ledger C may be manipulated.

In some embodiments, the transmitting module 34 of the computer program product 30 transmits the digital signature and the block chain ledger C to the mobile device 1 after the data transmitted from the mobile device 1 is verified. In some embodiments, the security module 32 is configured to generate the digital signature and the block chain ledger C based on a hush code.

After the identification data from the mobile device 1 is verified, the security module 32 generates a digital signature and a block chain ledger C corresponding to a block chain based on the data. In some embodiments, the identification data includes at least an activity parameter p, a user ID and a timestamp parameter t. The identification data of the user ID corresponds to a user of the mobile device 1. The mobile device 1 includes an interface for communicating with the computer program product 30 to performing the transaction on the block chain. In some embodiments, the interface includes an application installed on the mobile device 1. In some embodiments, the application may be displayed on a screen (not shown) of the mobile device 1. In some embodiments, the block chain ledger C includes a private key and a public key. The private key and a public key are stored on the security module 32.

In some embodiments, the identification data of the user ID comprises an identification of the mobile device 1. The identification data of the user ID comprises a number of an identity card (ID) of the user. In some embodiments, the identification data of the user ID comprises a user face identifier. The identification data of the user ID comprises a telephone number of the mobile device 1. The digital signature is generated by scanning a quick response (QR) code. The identification data of the user ID comprises a Facebook login. The identification data of the user ID includes a SIM card information of mobile device.

In some embodiments, the block chain ledger C includes a bit coin wallet or an Ethereum wallet. In some embodiments, the transmitting module 34 is configured to transmit the digital signature and the block chain ledger C to the mobile device 1. The mobile device 1 accesses the block chain by using the digital signature and the block chain ledger C to perform a transaction on the block chain. In some embodiments, the transaction on the block chain includes a bit coin transaction. In some embodiments, the transaction on the block chain includes an Ethereum transaction (but not limited) or other suitable block chain coin transactions.

In some embodiments, the transaction on the block chain corresponds to a real currency transaction. In some embodiments, the real currency transaction is performed on a related third party. The related third party may be a store or any seller. The related third party may give the real currency or the desired product to the user after the related third party verifies the transaction on the block chain has been completed. In some embodiments, the transaction on the block chain uses the coins provided by an owner. The owner provides the service for exchanging the block chain coins to cash. In some embodiments, the coin owner may be a vendor, a company, government, or any third party. The coins for the block chain can be exchanged to cash with the vendor, company, government, or any third party. The coins on the block chain may be used on any event, action or promotion defined by the coin owner.

The mobile device 1 includes a processor 10, a memory 12, a transmitting unit 14 and a receiving unit 16. The memory 12 is configured to store data. The transmitting unit 14 is configured to transmit the data to the computer program product 30. The receiving unit 16 is configured to receive the data from the computer program product 30. The processor 10 is configured to control the transmitting unit 14 for wirelessly transmitting the data to the mobile device 1 and control the receiving unit 16 for receiving the data from the mobile device 1.

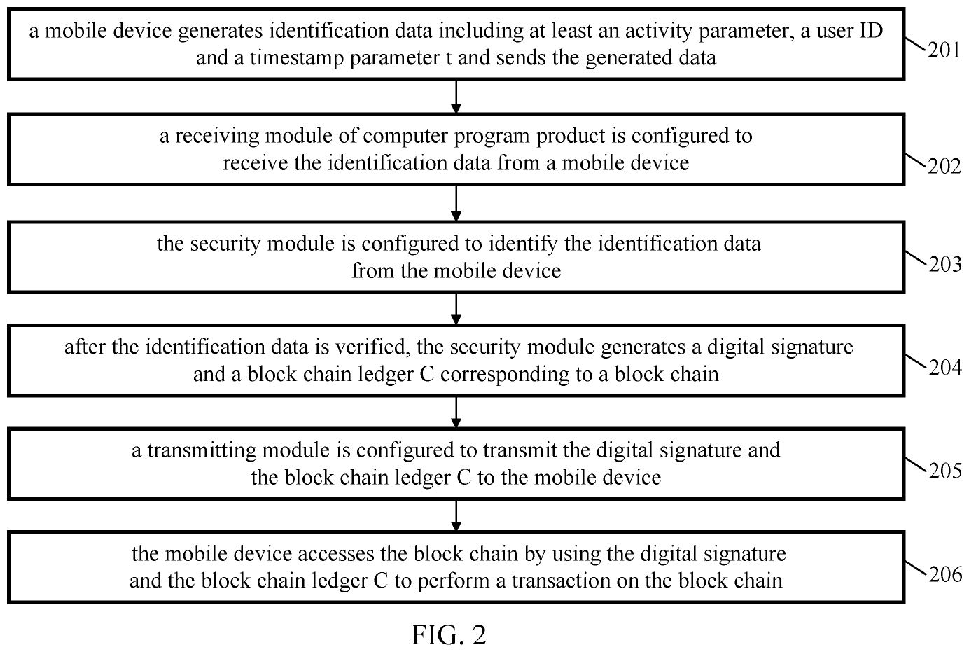

FIG. 2 illustrates a flow chart showing a method for performing a transaction on the block chain in accordance with some embodiments of the present disclosure. In some embodiments, the computer program product and mobile device can be the computer program product 30 and mobile device 1 as shown in FIG. 1. At step 201, a mobile device 1 generates identification data including at least an activity parameter p, a user ID and a timestamp parameter t and sends the generated data. At step 202, a receiving module 36 of computer program product 30 is configured to receive the identification data from a mobile device 1.

At step 203, the security module 32 is configured to identify the identification data from the mobile device 1. At step 204, after the identification data is verified, the security module 32 generates a digital signature and a block chain ledger C corresponding to a block chain as a function: C=f(ID, t, p). The identification data includes at least an activity parameter p, a user ID and a timestamp parameter t.

At step 205, a transmitting module 34 is configured to transmit the digital signature and the block chain ledger C to the mobile device 1. At step 206, the mobile device 1 accesses the block chain by using the digital signature and the block chain ledger C to perform a transaction on the block chain.

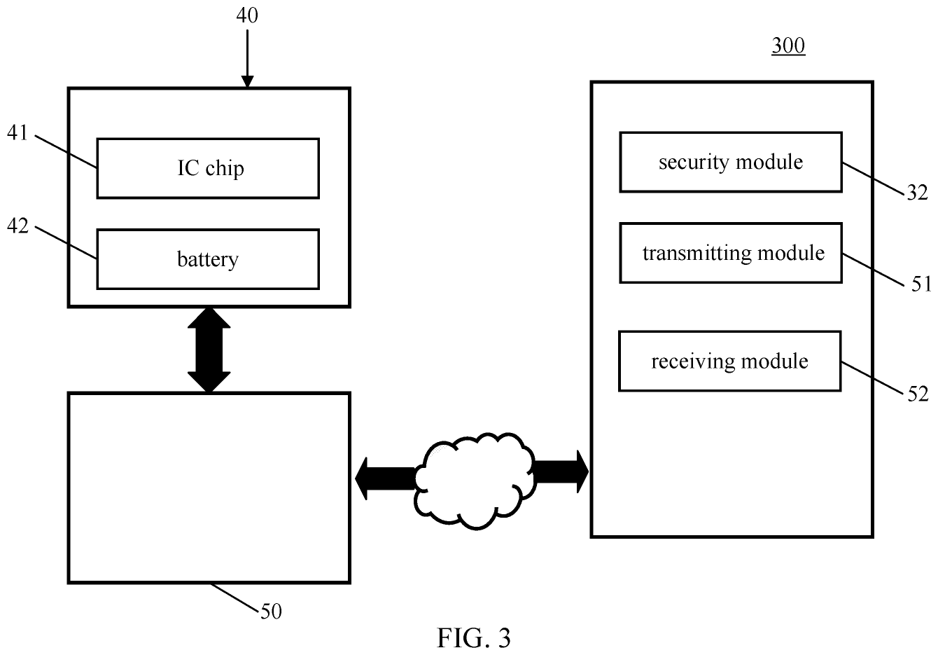

FIG. 3 illustrates a block diagram of a communication system 300 in accordance with some embodiments of the present disclosure. The communication system 300 may communicate with a smart card 40 through a mobile module 50. The communication system 300 is similar to the communication system 100. The mobile module 50 may be a reader to access the data stored in the smart card 40. The smart card 40 may include IC chip 41 and a battery 42. The battery provides the power supply to the IC chip 41. The data stored on the IC chip 41 is verified and modified by the communication system 300 through the mobile module 50. The data can be identified by the security module 32. The data stored on the IC chip 41 can be verified and modified by the security module 32 of the communication system 300. The mobile module 50 includes a transmitting module 51 and a receiving module 52. The transmitting module 51 transmits the data to the mobile module 50 and the receiving module 52 receives the data or instructions from the mobile module 50. In some embodiments, the IC chip 41 includes the digital signature and the block chain ledger C generated by the security module 32.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” or “about” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations do not limit the present disclosure. It can be clearly understood by those skilled in the art that various changes may be made, and equivalent elements may be substituted within the embodiments without departing from the true spirit and scope of the present disclosure as defined by the appended claims. The illustrations may not necessarily be drawn to scale. There may be distinctions between the artistic renditions in the present disclosure and the actual apparatus, due to variables in manufacturing processes and the like. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it can be understood that these operations may be combined, sub-divided, or re-ordered to form an equivalent method without departing from the teachings of the present disclosure. Therefore, unless specifically indicated herein, the order and grouping of the operations are not limitations of the present disclosure.

1. A system, comprising:
a receiving module configured to receive identification data of a user ID from a mobile device at a time with a timestamp parameter t;
a security module for storing activity parameter p, wherein the security module is configured to identify the identification data, the security module generates a digital signature and a block chain ledger C corresponding to a block chain as a function:
C=f(ID,t,p); and
a transmitting module configured to transmit the digital signature and the block chain ledger C to the mobile device, wherein the mobile device accesses the block chain by using the digital signature and the block chain ledger C to perform a transaction on the block chain.

2. The system of claim 1, wherein the identification data of the user ID comprises an identification of the mobile device.

3. The system of claim 1, wherein the identification data of the user ID comprises a number of an identity card (ID) of the user.

4. The system of claim 1, wherein the identification data of the user ID comprises a user face identifier.

5. The system of claim 1, wherein the identification data of the user ID comprises a telephone number of the mobile device.

6. The system of claim 1, wherein the digital signature is generated by scanning a quick response (QR) code.

7. The system of claim 1, wherein the identification data of the user ID comprises a Facebook login.

8. The system of claim 2, wherein the identification data of the user ID includes a SIM card information of mobile device.

9. The system of claim 1, wherein the mobile device further comprises an interface for perform the transaction on the block chain.

10. The system of claim 9, wherein the interface comprises an application installed on the mobile device.

11. The system of claim 1, wherein the block chain ledger C comprises a bit coin wallet.

12. The system of claim 1, wherein the block chain ledger comprises an Ethereum wallet.

13. The system of claim 1, wherein the transaction on the block chain comprises a bit coin transaction.

14. The system of claim 1, wherein the transaction on the block chain comprises an Ethereum transaction.

15. The system of claim 1, wherein the computer program product refers to a cloud server.

16. The system of claim 1, wherein the mobile device is a mobile phone.

17. The system of claim 1, wherein the transaction on the block chain corresponds to a real currency transaction.

18. The system of claim 18, wherein the real currency transaction is performed on a related third party.

19. The system of claim 1, wherein the security module is configured to generate the digital signature and the block chain ledger C based on a hush code.

20. The system of claim 1, further comprising:
a mobile module, wherein a smart card includes data stored thereon, and wherein the smart card includes an IC chip, wherein the data stored on the IC chip is verified and modified by the security module through the mobile module.

21. The system of claim 20, wherein the transmitting module transmits the data to the mobile module and the receiving module receives the data or instructions from the mobile module.

22. A method for performing a transaction on the block chain, comprising:
receiving identification data of a user ID from a mobile device at a time with a timestamp parameter t;
providing activity parameter p;
generating a digital signature and a block chain ledger C corresponding to a block chain as a function:
C=f(ID,t,p); and
storing the digital signature and the block chain ledger C in the block chain.
